(19) United States
(12) Patent Application Publication
(10) Pub. No.: US 2004/0257199 A1
(43) Pub. Date: Dec. 23, 2004

(54) Entry control system

(76) Inventors: James J. Fitzgibbon, Batavia, IL (US); Neil R. Peplinski, North Barrington, IL (US); Eric A. Templeton, Lombard, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 10/715,988

(22) Filed: Nov. 18, 2003

Related U.S. Application Data
(63) Continuation-in-part of application No. 09/752,955, filed on Jan. 2, 2001, now abandoned.
Application No. 09/752,955 is a continuation-in-part of application No. 09/577,336, filed on May 22, 2000, now abandoned.
(60) Provisional application No. 60/175,749, filed on Jan. 12, 2000.

(51) Int. Cl. G06F 7/04

(52) U.S. Cl. 340/5.71; 340/5.51

(57) ABSTRACT

An entry control system and method for permitting authorized users to access a controlled area by moving a barrier comprises a specific action button and an entry request device for accepting a user data input. A controller is operably coupled to the entry request device and the specific action button and having an output. The transmitter receives the user data input and an indication of a position of the barrier and determines based at least in part upon the user data input and the indication of the position of the barrier whether a first control signal should be generated at the output, the controller also receiving an indication of an actuation of the specific action button and selectively generating a second control signal at the output based at least in part upon the indication of the position of the barrier.

### CROSS REFERENCE TO RELATED APPLICATIONS

This application is a continuation-in-part of copending application Ser. No. 09/752,955 filed on Jan. 2, 2001, which claims priority from continuation-in-part of U.S. application Ser. No. 09/577,336, filed May 22, 2000, which claims priority from U.S. provisional application No. 60/175,749, filed Jan. 12, 2000.

### BACKGROUND OF THE INVENTION

The invention relates in general to a method and apparatus for authorizing entry into a controlled area and in particular to a method and apparatus for enabling access to an area for delivery and pickup of commercial goods.

Many individuals today are confronted with situations where there is no one at their home when access is required for delivery or pickup of goods or for performance of home repair services. Most people work during the day and are not able to be at home to accept goods being delivered, allow service people into their house to service appliances or perform installations such as, for example cable or telephone lines. Moreover, when trying to arrange a time to be home for delivery and repair services these service providers usually require someone to be at the house for half a day and will not pinpoint a specific arrival time. Increased ordering of goods on the Internet has created a greater need for facilitating home deliveries while the homeowner is at work. Home delivery of groceries requires some method to receive deliveries on a regular basis. For valuable goods or bad weather leaving delivered goods outside the house in an unsecured area is not a viable option. Further if the deliverer of the goods holds the goods to arrange to have the consumer pick them up, say during the weekend, the consumer is severely inconvenienced by the time delay in receiving the goods.

Some catalogue and on-line merchants have arranged to have local stores such as convenience stores with extended hours to hold goods to be picked up close to home when the purchaser leaves work. However, this requires a substantial investment in developing such a network of “brick and mortar” delivery locations which are convenient in location and operating hours for a significant number of consumers.

Many homes have entry systems which control various access points for the home, such as, for example, the automatic garage door operator which raises and lowers the garage door after it receives an appropriate signal from the associated control circuitry. Generally such control systems include input devices such as wall mounted keypads, hand held radio frequency transmitters or simple actuating buttons. Typically, security measures are imposed in these garage door opening systems to prevent unauthorized access to the garage area. For example, a keypad mounted on an exterior wall would require the entry of a secret code to allow the operation of the garage door operator for opening the garage door. Additionally, garage door operator hand held transmitter units communicate with the control circuitry of the garage door operator via encoded signals which attempt to ensure that only authorized individuals are granted access to the garage area. These type of systems are not limited to garage door operation but maybe extended to entry gates or even the front door lock mechanism of the house itself

With a garage door entry system a homeowner could give the delivery services a programmable code which can be entered in a keypad on an outside wall of the door. For security reasons the homeowner would not wish to give a third party permanent means to gain access to any part of their home while they are away. Some homes have home security systems which monitor entry into certain portions of the house including the garage door so that even if delivery personnel were given a code to open the garage door, security would further be compromised because they would need to have the code to deactivate the home security system at the time the goods were delivered. The same considerations would apply to having articles, such as, for example, dry cleaning, picked up. Leaving articles outside is not secure nor is it advisable to give third parties access to any part of the home for pick up or delivery.

### SUMMARY OF THE INVENTION

A principal object of the present invention is to provide an entry control system for permitting authorized users to access a controlled area. The entry control system has an access controller for generating an entry signal, an entry operator operatively coupled to the access controller which when actuated by an entry signal controls whether a predetermined area of the controlled area can be entered, and an authentication system operatively coupled to the accessed controller which determines whether a user is one of a group of authorized users, whether that user is authorized to access said predetermined area at a predetermined time and whether a prior access to the controlled area prohibits authorization for entry. In one aspect of the invention the predetermined area of the controlled area comprises a security zone defined by a home security system.

An object of the present invention is that users of the system may be granted access to a predefined zone of a home secured by a home security system so that service personnel such as repairmen, cable or telephone installers may be permitted to gain entry to areas necessary for them to perform their duties but no other areas.

In still another object of the present invention the access is limited by the number of entries already granted to the user of the system. Thus, after the service provider has entered to make repairs, or to perform the pick up or delivery of the designated items, the access authorization will no longer be recognized for purposes of permitting entry to the controlled resource such as the garage.

The entry control system of the present invention by permitting authorized users access to a controlled area such as the homeowners garage facilitates home deliveries while the homeowner is at work by making it possible to have articles left in a secure location without compromising the overall security for the home. The individual requiring ability to have unattended access to the home may with the present invention control entry by identifying an authorized user group and defining parameters for access such as the area of the home to be accessed, the time at which the access can be made and the number of times a designated authorized user can gain access.

The present invention allows for third party management of the entry control system so that delivery and pick up of goods can be fully managed by either the merchant or a contracted delivery service without requiring the time and overhead to schedule special times to meet the homeowner or developing a network of convenient delivery locations.

Other aspects and advantages of the present invention will become obvious to one of ordinary skill in the art upon review of the following specification and claims in light of the accompanying drawings.

### BRIEF DESCRIPTION OF THE DRAWINGS

FIG. 1 is a block diagram of an entry control system embodying the present invention;

FIG. 2 is a view of a keypad of the entry control system shown in FIG. 1;

FIG. 3 is a block diagram of the entry control system shown in FIG. 1 and utilizing radio frequency identification tags;

FIG. 4 is a block diagram of an entry control system used with a home security system in accordance with another embodiment of the invention;

FIG. 5 is a clock diagram of an entry control system embodying the present invention; and

FIG. 6 is a flowchart of the operation of the system by using a specific action button in accordance with the present invention.

### DETAILED DESCRIPTION OF THE PREFERRED EMBODIMENTS

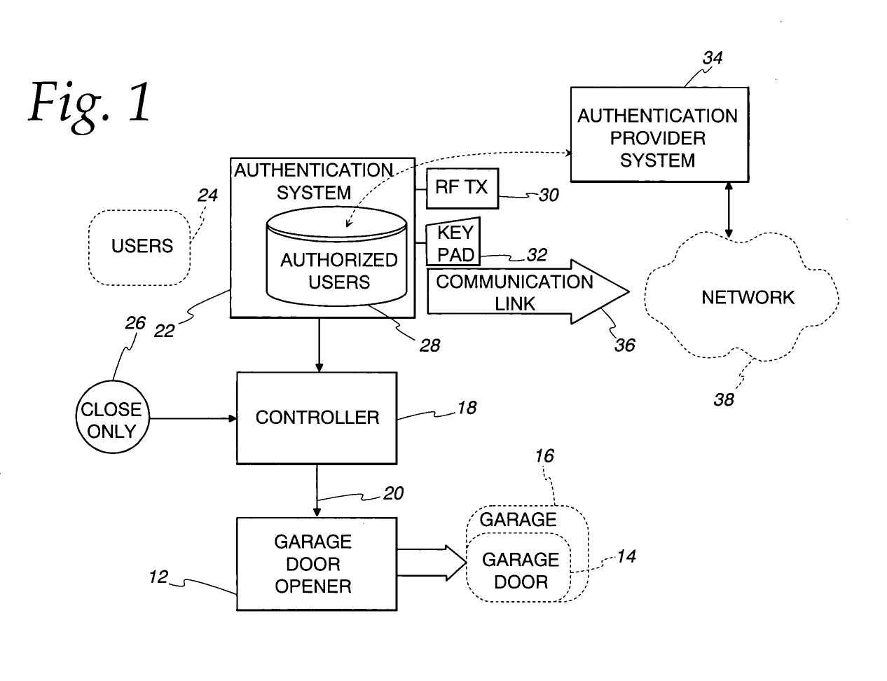

Referring now to the drawings and especially to FIG. 1, an apparatus embodying the invention is shown therein and generally identified by reference numeral 10. The apparatus 10 or entry control system 10 has a garage door operator 12 for permitting authorized users to access a controlled area. The garage door operator 12 operates a garage door 14 of a garage 16. A controller 18 generates a control signal 20 which causes the garage door operator 12 to either open or close the garage door 14. In the presently preferred embodiment of the invention operation of garage door operator 12 is restricted to the homeowner or other users who are authorized by the homeowner by an authentication system 22. Preferably garage door entry control system 10 is operable by a limited number of RF transmitters 30 which are carried in the vehicles stored in the garage. The RF transmitter 30 allows the owner to operate the entry control system 10 to open the garage door 14 from inside a vehicle.

The authentication system 22 receives input from hand-held RF transmitters 30, keypad 32 and communication link 36. RF transmitter 30 and keypad 32 send request for opening and closing garage door 14 which are processed by authentication system 22. Preferably authentication system 22 receives communications which must be decoded and decrypted and which contain access codes. In the presently preferred embodiment those access codes or access designations as shown in FIG. 1 are represented as being stored as authorized users 28. Once the authentication system 22 confirms that a user is one of authorized users 28 then the controller 18 sends a control signal 20 to the garage door operator 12 so that the garage door 14 is opened. The keypad 32 is installed on the outside of the garage 14 to permit operation of garage door 16 after entry of an access code into keypad 32. A user 24 would actuate the RF transmitter so that a signal would be sent to the authentication system 22 which would then validate the received RF signal and cause the controller 18 to send a signal 20 to the garage door operator 12 so that the garage door 14 would be opened and the user 24 may then enter the garage 16.

It is known that for safety reasons operation of a garage door should be by line of sight only or at least by users 24 in close proximity. A “close only” button 26 when activated will cause garage door 14 to close if it is already open. The garage door operator 12 can be any of a number of known configurations such as a belt drive, chain drive or other mechanism which cooperates with the garage door 14 to automate opening and closing of garage door 14.

The authentication system 22, depending upon the level of security used by the entry control system 10, will decode or otherwise receive the transmitted radio frequency signal and translates it into a signal which may be compared to signals from authorized users 28. That is, the transmitted radio frequency signal will contain a coded designation which will be checked for correspondence with one or more entries in a list of coded designations or authorized users 28 by the authentication system 22. If the transmitted signal corresponds to a designation within authorized users 28 the appropriate signal is sent to the controller 18 which will then cause control signal 20 to activate the garage door operator 12 causing garage door 14 to open or close.

Operation of the keypad 32 is functionally similar to RF transmitter 30. The keypad 32 shown in FIG. 1 is intended to represent a keypad which may be found at an unsecured location such as an outside wall 33 of the garage 16. The keypad 32 is connected to the authentication system 22 in such a way that users 24 desiring access to garage 16 may enter a security code or other pass code which will allow entry control system 10 to authenticate the user as one of authorized users 28. The keypad 32 may be connected to authentication system 22 via a radio frequency (RF) link in which case the communication transmission to the authentication system 22 would be essentially identical to that of radio frequency transmitter 30. The keypad 32 may be hard wired to the authentication system 22.

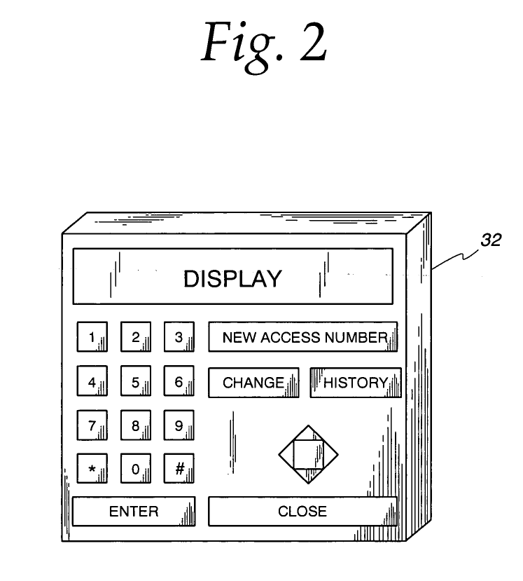

The full featured keypad 32 shown in FIG. 2 can be used to manually program various functionalities or parameters for authorized access such as the number of entry operations, limits on time of day, or limits on the absolute period of operation. The owner of the entry control system 10 would program such functionality into the keypad 32 or the owner may access this programming via a communication link 36.

A communication link 36 which may be used to couple the entry control system 10 to a plurality of systems and networks 38 which are not physically located at entry control system 10 is shown in FIG. 1. The communication link 36 may represent either alternatively or in any combination an Internet connection, a land line wired connection, a wireless network, a packet switched network link, a public standard telephone network connection or an IR communication link. The communication link 36 connects the entry control system 10 into the network 38 or another node within the network 38 which is either local, i.e., a household network, or public network such as the Internet.

In accordance with a present preferred embodiment of the invention the communication link 36 and the network 38 provide the communication link from an authentication provider system 34 to the entry control system 10 so that access can be granted to the garage 16 for the purposes of allowing delivery and pick up of goods when needed. The authentication provider system 34 is accessed when it is desired to permit a user 24 to enter the garage 16 for purposes such as pick up or delivery of items, or performing services such as repair of appliances or reading meters, etc. The authentication provider system 34 is coupled to the designations of authorized users 28 in order to control the authorization of access granted. A delivery service requiring access to the garage 16 is assigned a designation or access code which will be valid within the authorized users 28 for a limited or predefined period of time as determined by the authentication provider system 34.

The operative parameters or entry limitations are communicated to the entry control system 10 through the network 38 and the communication link 36. Depending upon the type and nature of the communication link 36, the network 38 and the data security used across these elements, the limitations or scope of access parameters may be stored locally in entry control system 10 or stored in an off-site location which may or may not be part of the actual physical authentication provider system 34 and may essentially consist of a distributed data base of authorized users 28.

The parameters associated with an authorized users permission to access garage 16 is the designation of the user within the group of authorized users 28, the number of prior accesses granted to that user and time limitations such as time of day and duration of access granted.

Authentication provider system 34 must issue something to the intended user which in this example will be a delivery person, which the delivery person can use to communicate to entry control system 10 that they are permitted entry to garage 16 because they have the designation corresponding to one of authorized users 28 and meet the other access permission parameters. Additionally, security measures should be implemented so that the intended delivery person is the only person allowed into garage 16 based on the assigned parameters for that user. That is, authentication provider system 34 is to communicate some data either physically or via a communication link which would uniquely identify the delivery person to entry control system 10. Preferably the delivery person can be issued a access code which when they approach the garage door they may enter into keypad 32 in order to gain entry into garage 16.

Increased security can be provided by having biometric identification information stored within the parameters associated with each designation of one of authorized users 28. Accordingly, biometric scanning or identification device would be, such as, for example, a retinal scanner, not shown, maybe directly coupled to authentication system 22 to uniquely identify that the intended delivery person is attempting to gain access. Other type security identification devices may be used such as, magnetically or RF encoded smart cards which may or may not include biometric information for the holder of the card.

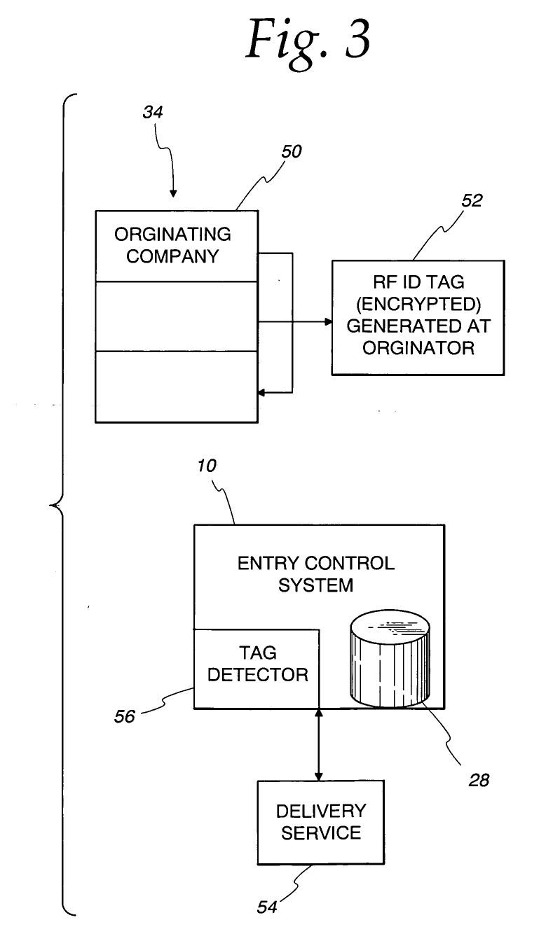

In FIG. 3 an illustration authentication provider system 34 is illustrated. Originating company 50 for a package being delivered is responsible for issuing an RF ID tag 52. RF ID tag 52 contains identifying information of the delivered article so that when delivery service 54 arrives at the package destination tag detector 56 interrogates RF tag information from the package and compares it to information downloaded through communication link 36 to match the designation and permission parameter information to that stored within the data base of authorized users 28. If the package delivery service are present at entry control system 10 within the prescribed limits then access to garage 16 will be granted in order to leave the package.

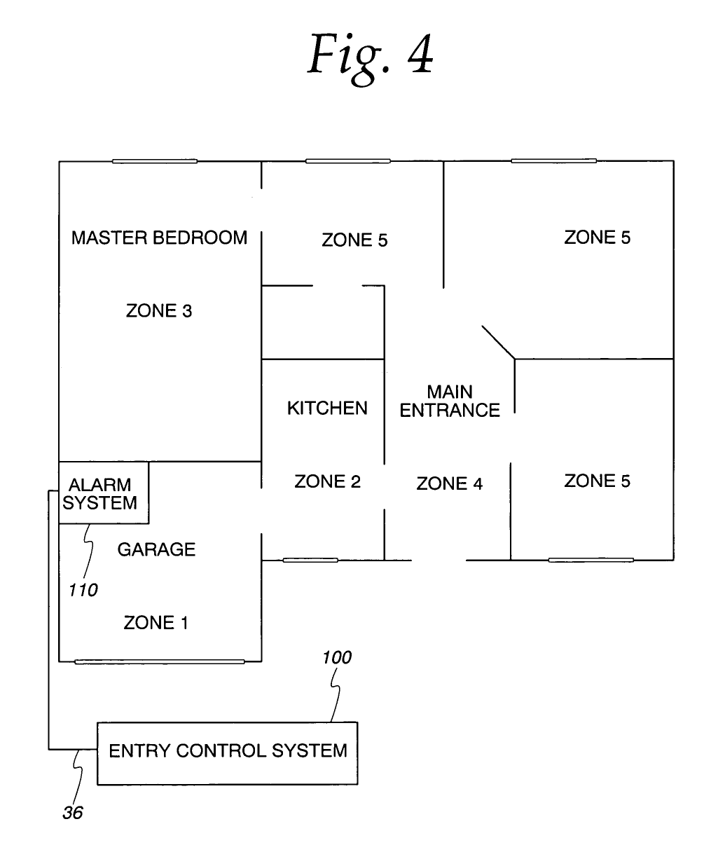

FIG. 4 illustrates an alternative embodiment of the entry control system of the present invention which is designated generally by reference numeral 100. As is the discussed with reference to entry control system 10 access has been controlled by direct control of the physical entry system which in the case of garage 16 is garage door 14. However, in the case where there is an alarm system for the home and garage 16 is within a zone of the monitored home security system will then even if garage door 14 is opened a delivery person will not be able to enter garage 14 without setting off an alarm within alarm system 110. Accordingly, a portion of communication link 36 may be connected to alarm system 110 in order to disable all or just the necessary zone of alarm system 110 so that a delivery person making a delivery will not set off the alarm when garage door 14 opens and physically grant access to the delivery person.

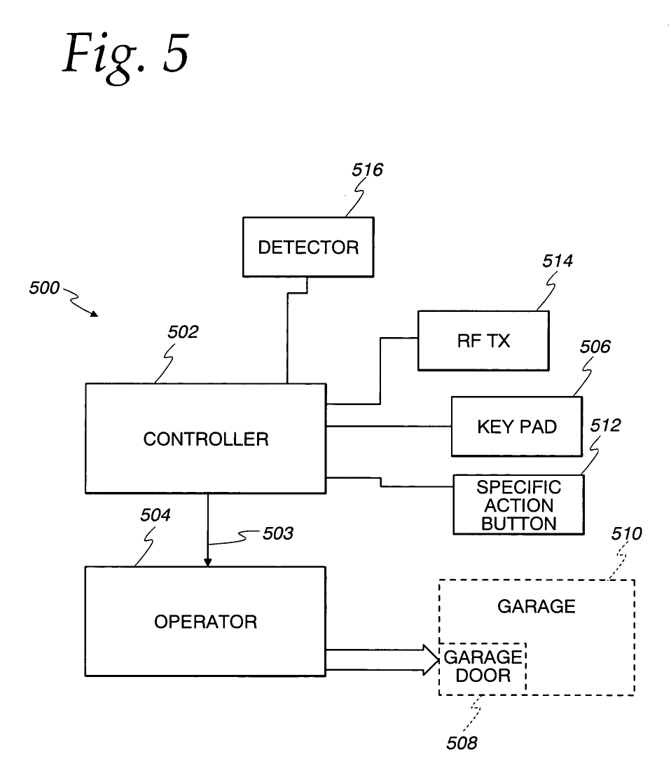

Referring now to FIG. 5, an example of a system 500 using a specific action button is described. The system 500 includes a controller 502, a garage door operator 504, a keypad 506, and a garage door 508 within a garage 510. A specific action button 512 may be placed on the keypad 506 or separate from the keypad 506. In addition, an RF transmitter 514 allows the owner to operate the entry control system 500 to open the garage door 508 from inside a vehicle. Alternatively, the keypad 506 may also be used to open the garage door 508.

Although not shown in FIG. 5, portions of an authentication system as shown and described with respect to FIGS. 1-4 may also be included as a part of the system 500. For example, the specific action 512 in FIG. 5 is the close only button 26 in FIG. 1. The keypad 506 in FIG. 5 is the keypad 32 in FIG. 1. The controller 502 of FIG. 5 is controller 18 in FIG. 1. The operator 504 in FIG. 5 is the operator 12 in FIG. 1. The garage door 508 in garage 510 of FIG. 5 is the garage door 14 in garage 16 of FIG. 1. Thus, the description made below with respect to FIG. 5 is not limited to the exact configuration shown, and may be incorporated into systems such as those previously described.

In a preferred approach, the specific action button is a close button such as close only button 26 so that actuating the button causes the door 508 to close. However, the specific action button 512 is not limited to use as a close button, but may also be used as a stop, open, light or learn button. In addition, as described below, the specific action button 512 may perform multiple functions, for instance, performing certain functions during certain periods of time or during the performance of different operations by the system 500.

The controller 502 generates a control signal or signals 503 which cause the garage door operator 504 to either open or close the garage door 508. The controller 502 may receive information concerning the actuation of the specific action button 512 and the position of the door 508 or only information concerning actuation of the specific actuation button 512.

If the controller 502 receives both types of information, then the controller 502 generates a control signal 503 to the operator 504 instructing the operator 504 to open, close, or halt movement of the door 508. The operator 504 receives the control signal 503 and causes the garage door 508 to open, close, or halt. On the other hand, if the controller 502 receives only information indicating the actuation of the specific actuation button 512, then such information is transmitted to the operator 504. The operator 504 next examines the present state of the garage door 508 and makes the determination of whether to open, close, or halt the movement of the garage door 508. The operator 504 then creates a signal to open, close, or halt movement of the door 508. Similarly, in arrangements where the function requested by the specific action button varies with time or the type of function being requested by the controller, the controller generates control signals based in part on time or functions being performed.

The system 500 may be operated in both a secure and unsecured mode of operation. When the keypad 506 is used to move the door 508, the user may be required to enter an authorization code, for instance, a PIN number, in order to be able to use the system 500 to move the door 508. Alternatively, if the system 500 is unsecured, no authorization information need be received from the user via the keypad 506.

The specific action button 512 may be learned by the system 500. In this regard, a learn close button may be present on the keypad 506. When the learn close button is pressed, a timer is started and decremented to zero over a delay period. Upon the expiration of the delay period, the keypad 506 transmits an open command to the controller 502. The keypad 506 may also annunciate that it is transmitting by either blinking or beeping. In order not to leave an unsecured open button on the keypad, either the rolling code transmitted from the keypad 506 will not advance or the rolling code will jump to a value so as not to allow operation. As a result of this approach, a fixed code is stored in a memory location at the controller 502 along with an indication that this fixed code is associated with the specific action button 512. It is not necessary to store the rolling code in the memory location. Only the fixed code associated with the specific action button is required to be stored.

The system 500 has the ability to stop the door while the door is traveling. In one approach, a timer can be activated when the specific action button 512 is actuated. While the timer is active and the specific action button 512 is pressed again, then a stop command is transmitted from the controller 502 to the operator 504. The controller 502 can then either reset the timer, returning to the ability to be a close command, or continue the timer until the timer expires.

Pressing the specific action button 512 causes the transmission of a coded transmission that is either known by or previously learned by the operator 504. In one example, the code may be a keypad value that would be impossible to generate from the keypad 506. In another example, the code may be an identification value that is unique in the system 500. In yet another example, the code may be a rolling code value, which has a jump of a specific distance from a prior rolling code. In still another example, the code may be a different serial number with the last transmitted information. The codes and coding scheme may be of the type described in U.S. Pat. No. 6,154,544 entitled “Rolling Code Security System,” which is incorporated herein by reference in its entirety.

Various delays can be built into the system so that when the specific action button is actuated, a delay period must expire before an action is taken. In one example, the specific action button 512 can be pressed and the controller 502 may wait a predetermined amount of time to issue a close command to the operator 504. This is advantageous when the user wishes to have a built-in amount of time to clear obstructions from the garage door before the door 508 is closed.

The function of the single-action button 512 may change function after its initial activation. For example, a timer may be set to indicate that a specific action button 512 would be a close button when the system is at rest and become a stop button 15-30 seconds after the specific action button 512 is first activated to close the door.

Various security features may also be used in the system 500. For example, the specific actuation button 512 may not be activated until a specific RF-ID tag is within range of the controller 502 and the controller 502 receives and verifies this information. The RF-ID tag may be on a package or on the person attempting entry. In another example, the specific action button is not activated until a biometric signature (e.g., a fingerprint) is received. In this case, a biometric identification system is coupled to the controller 502 in order that the controller 502 may receive and verify this information. An ancillary detector 516 may be used to receive the RF-ID or biometric information.

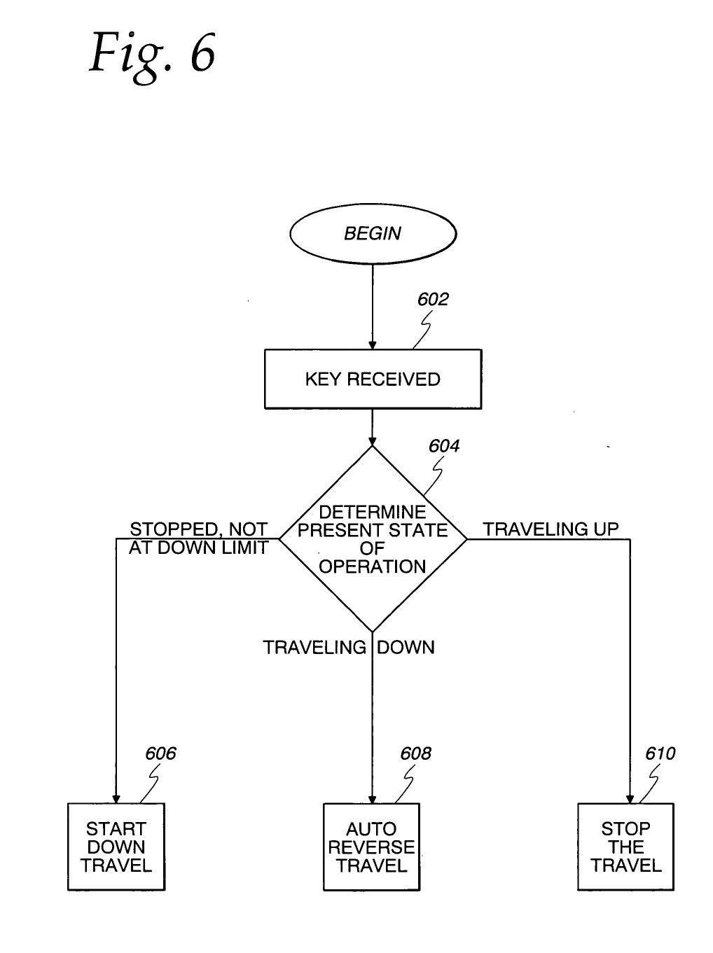

Referring now to FIG. 6, an example of the decision to make is described. This algorithm may be implemented entirely in the controller 502 of FIG. 5 or partially in the controller 502 and partially in the operator 504.

At step 602, a key value representing a specific action button is received and the code is verified. At step 604, the present state of the garage door is determined. If the present state of garage door is that the garage door is stopped but not at the down limit, then execution continues at step 606 where down travel for the door is initiated. If the present state of operation of the door indicates that the door is traveling down, then at step 608, the travel of the door is automatically reversed at step 610. If the present state of operation is that the door is traveling up, then at step 612 travel of the door is halted.

While there have been illustrated and described particular embodiments of the present invention, it will be appreciated that numerous changes and modifications will occur to those skilled in the art, and it is intended in the appended claims to cover all those changes and modifications which fall within the true spirit and scope of the present invention.

What is claimed is:

1. An entry control system for permitting authorized users to access a controlled area by moving a barrier, comprising:
a specific action button;
an entry request device for accepting a user data input;
a controller operably coupled to the entry request device and the specific action button and having an output,
such that the controller receives the user data input and an indication of a position of the barrier and determines based at least in part upon the user data input and the indication of the position of the barrier whether a first control signal should be generated at the output, the controller also receiving an indication of an actuation of the specific action button and selectively generating a second control signal at the output based at least in part upon the indication of the position of the barrier.

2. The system of claim 1 comprising a receiver communicatively coupled to the transmitter at the output, the receiver receiving the first and second control signals.

3. The system of claim 2 comprising a barrier operator coupled to the receiver, the operator selectively moving the barrier upon receipt of the first and second control signals.

4. The system of claim 1 wherein the entry request device is a keypad.

5. The system of claim 1 wherein the first control signal opens the barrier and the second control signal closes the barrier.

6. The system of claim 1 wherein the specific actuation button may be a close button, a stop button, an open button, a light button, or a learn button.

7. The system of claim 1 wherein the specific action button changes function after a predetermined time period.

8. The system of claim 1 comprising apparatus for detecting an RF-ID, and wherein the second control signal is not transmitted unless the controller detects an RF-ID.

9. The system of claim 1 wherein the second control signal is not transmitted unless the controller receives a biometric signature.

10. The system of claim 1 wherein the generation of the control signals is delayed for a predetermined time after the actuation of the specific action button.

11. An entry control system for permitting authorized users to access a controlled area by moving a barrier, comprising:
a specific action button;
an entry request device for accepting a user data input;
a controller operably coupled to the entry request device and the specific action button and having an output,
such that the controller receives the user data input and determines based at least in part upon the user data input whether a first control signal should be generated at the output, the controller also receiving an indication of an actuation of the specific action button and selectively generating a second control signal.

12. The system of claim 11 comprising a receiver communicatively coupled to the transmitter at the output, the receiver receiving the first and second control signals.

13. The system of claim 12 comprising a barrier operator coupled to the receiver, the operator selectively moving the barrier upon receipt of the first and second control signals.

14. The system of claim 11 wherein the entry request device is a keypad.

15. The system of claim 11 wherein the first control signal opens the barrier and the second control signal closes the barrier.

16. The system of claim 11 wherein the specific actuation button may be a close button, a stop button, an open button, a light button, or a learn button.

17. The system of claim 11 wherein the specific action button changes function after a predetermined time period.

18. The system of claim 17 wherein the specific action button changes from a close button to a stop button.

19. The system of claim 11 comprising apparatus for detecting an RF-ID, and wherein the second control signal is not transmitted unless the controller detects an RF-ID.

20. The system of claim 11 wherein the second control signal is not transmitted unless the controller receives a biometric signature.

21. The system of claim 11 wherein the generation of the control signals is delayed for a predetermined time after the actuation of the specific action button.
